(19) United States
(12) Patent Application Publication
(10) Pub. No.: US 2025/0360778 A1
(43) Pub. Date: Nov. 27, 2025

(54) CAR WINDOW SUNSHADE PROTECTIVE COVER

(71) Applicant: Zhiling LIU, Guangzhou (CN)

(72) Inventor: Zhiling LIU, Guangzhou (CN)

(21) Appl. No.: 18/928,236

(22) Filed: Oct. 28, 2024

(30) Foreign Application Priority Data
May 24, 2024 (CN) 2024211634387

(51) Int. Cl. B60J 1/20

(52) U.S. Cl. CPC B60J 1/2011

(57) ABSTRACT

A car window sunshade protective cover includes an inner sleeve, an outer sleeve, an inner elastic member, and an outer elastic member. The inner sleeve includes an inner edge strip and a shielding member, and parts of edges of the shielding member are detachably connected to an inner edge of the inner edge strip. The outer sleeve includes an outer edge strip and a grille member, and the grille member is connected to an inner edge of the outer edge strip. The inner elastic member is disposed on and connected to a side edge of the inner edge strip. The outer elastic member is disposed on and connected to a side edge of the outer edge strip. the inner sleeve and the outer sleeve are configured to be sleeved onto the framed car window through the opening. The protective cover achieves un protection, mosquito-proofing, and shading.

### TECHNICAL FIELD

The disclosure relates to the technical field of car sunshade, and particularly to a car window sunshade protective cover.

### BACKGROUND

Cars are a common means of transportation for many modern individuals or families. Whether it's for work, leisure, or other purposes, cars are frequently used. Sometimes, for various reasons, drivers or passengers need to open the car windows appropriately to maintain ventilation inside the car, which can be energy-efficient and allow for breathing in fresh, clean air from outside.

During the summer driving process, there can be interference from mosquitoes and sunlight, preventing drivers and passengers from freely ventilating by opening windows. Although there are mosquito-proofing structures in the related art, these structures mainly rely on mesh fabrics for mosquito-proofing, which is insufficient for meeting the needs of sun protection in strong ultraviolet environments. The existing technological device lacks sun protection devices that can cope with different environments.

### SUMMARY

The disclosure provides a car window sunshade protective cover, which aims to solve the problem of insufficient functionality of current technical equipment to meet the needs of sunshade protective equipment in different environments.

A car window sunshade protective cover is applied to a framed car window, which includes an inner sleeve, an outer sleeve, an inner elastic member, and an outer elastic member. The inner sleeve includes an inner edge strip and a shielding member (i.e., shielding plate), and parts of edges of the shielding member are detachably connected to an inner edge of the inner edge strip. The outer sleeve includes an outer edge strip and a grille member, and the grille member is connected to an inner edge of the outer edge strip. The inner elastic member is disposed on and connected to a side edge of the inner edge strip. The outer elastic member is disposed on and connected to a side edge of the outer edge strip. A side edge of the inner sleeve connecting to the inner elastic member and a side edge of the outer sleeve connecting to the outer elastic member together define an opening, the inner sleeve and the outer sleeve are configured to be sleeved onto the framed car window through the opening.

In an embodiment, rest three side edges of the inner sleeve without connecting to the inner elastic member are connected to rest three side edges of the outer sleeve without connecting to the outer elastic member, respectively.

In an embodiment, a side edge of the shielding member close to the inner elastic member is connected to the inner edge of the inner edge strip, and rest side edges of the shielding member are detachably connected to the inner edge of the inner edge strip.

In an embodiment, the outer edge strip is provided with a first connecting piece and a second connecting piece, the first connecting piece is overlapped and connected with and the second connecting piece.

In an embodiment, a Velcro is provided on overlapping surfaces between the first connecting piece and the second connecting piece.

In an embodiment, the shielding member is connected to the inner edge of the inner edge strip through a zipper connection manner.

In an embodiment, the shielding member includes a first shielding member and a second shielding member. When the inner sleeve and the outer sleeve are sleeved onto the framed car window, the second shielding member is disposed to be closer to a car rearview mirror than the first shielding member.

In an embodiment, a side edge of the first shielding member close to the inner elastic member is connected to the inner edge strip, the first shielding member is movably connected with the second shielding member, and a side edge of the first shielding member facing away from the second shielding member is movably connected to the inner edge of the inner edge strip.

In an embodiment, a side edge of the second shielding member close to the inner elastic member is connected to the inner edge strip, and a side edge of the second shielding member facing away from the first shielding member is movably connected to the inner edge of the inner edge strip.

In an embodiment, each of the inner elastic member and the outer elastic member is made of an clastic material, and the inner elastic member and the outer elastic member are pressed against a contour of a car door by a force of elasticity.

Compared to the related art, the beneficial effects of the disclosure are as follows.

The car window sunshade protective cover provided by the disclosure includes a shielding member, a side edge of the shielding member close to the inner elastic member is connected to the inner edge of the inner edge strip, and rest side edges of the shielding member are detachably connected to the inner edge of the inner edge strip. By opening and closing the shielding member in conjunction with a grille member, it meets the needs for mosquito-proofing and sunshade under different conditions, achieving multiple combination functions to meet the needs for sun protection, mosquito-proofing, and shading under different conditions during driving.

### BRIEF DESCRIPTION OF DRAWINGS

FIG. 1 illustrates a schematic structural diagram of a car window sunshade protective cover and a framed car window of the disclosure.

FIG. 2 illustrates a schematic structural diagram of the car window sunshade protective cover of the disclosure.

FIG. 3 illustrates a schematic diagram of an inner sleeve of the car window sunshade protective cover of the disclosure.

FIG. 4 illustrates an enlarged schematic diagram of a portion A illustrated in FIG. 2 in the disclosure.

FIG. 5 illustrates a schematic structural diagram of a first shielding member and a second shielding member of the car window sunshade protective cover in the disclosure.

FIG. 6 illustrates a schematic structural diagram of a Velcro in the disclosure.

### DESCRIPTION OF REFERENCE NUMERALS

100. framed car window; 200. protective cover; 210. inner sleeve; 211. inner edge strip; 212. shielding member; 2121. first shielding member; 2122. second shielding member; 213. inner chain; 214. inner elastic member; 220. outer sleeve; 221. outer edge strip; 222. grille member; 223. outer elastic member; 2241. first connecting piece; 2242. second connecting piece; 2243. installation hole; 300. opening; 400. car rearview mirror; 231. hair surface of Velcro; 232. hook surface of Velcro.

### DETAILED DESCRIPTION OF EMBODIMENTS

Unless otherwise defined, all technical and scientific terms used in the disclosure have the same meaning as understood by those skilled in the art to which the disclosure pertains. The terms used in the specification of the disclosure are for the purpose of describing specific embodiments only and are not intended to limit the disclosure. The terms “include” and “have” and their conjugations as used in the specification and claims of the disclosure and the above-described drawings are intended to cover non-exclusive inclusion. The terms “first” and “second” as used in the specification, claims, or the above-described drawings, are used to distinguish different objects and are not intended to describe a specific order.

In the disclosure, the term “embodiment” means that the specific features, structures, or characteristics described in conjunction with the embodiment may be included in at least one embodiment of the disclosure. The appearance of this phrase at various places in the specification does not necessarily refer to the same embodiment, nor does it refer to an independent or alternative embodiment that is exclusive of other embodiments. It is understood by those skilled in the art, both explicitly and implicitly, that the embodiments described in the disclosure can be combined with other embodiments.

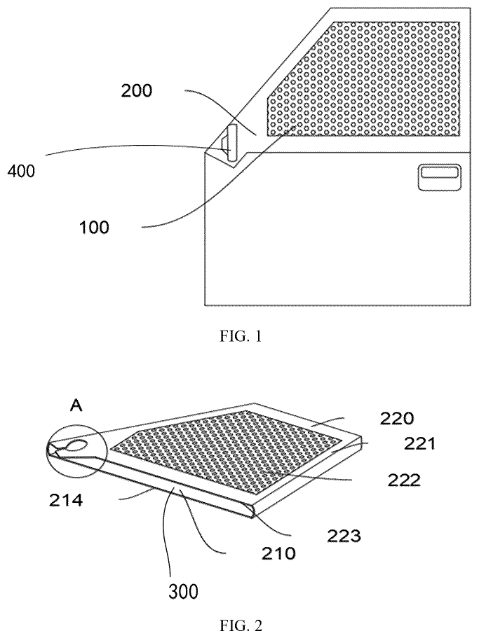

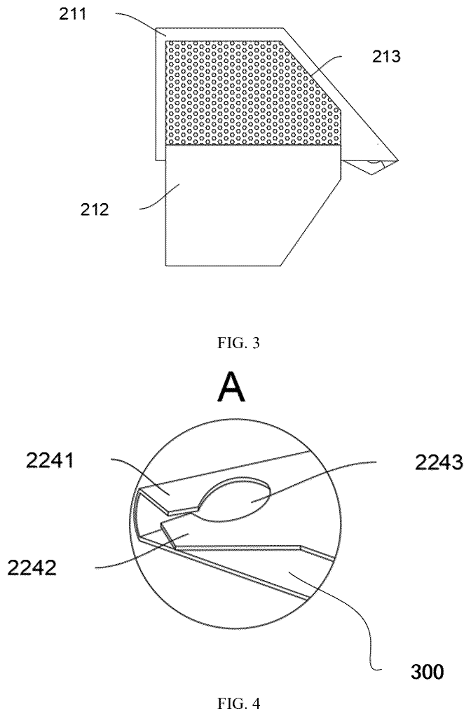

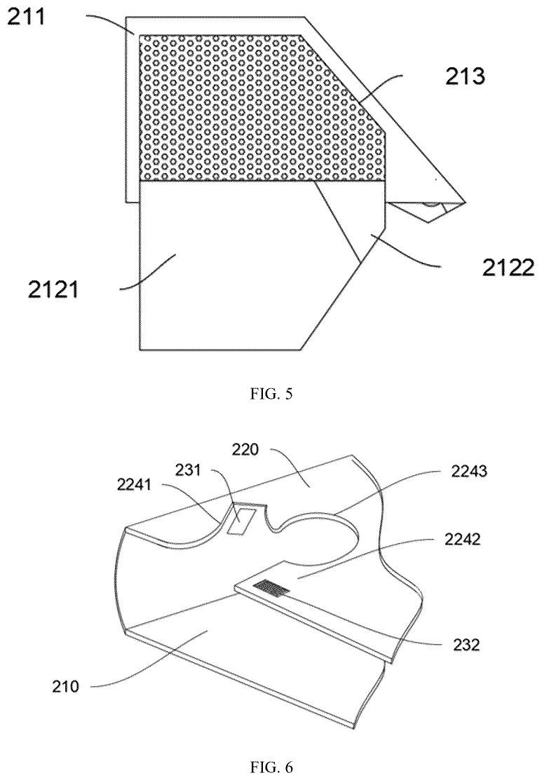

As shown in FIGS. 1-5, a car window sunshade protective cover is provided, which is applied to a framed car window 100. The car window sunshade protective cover includes an inner sleeve 210, an outer sleeve 220, an inner elastic member 214, and an outer elastic member 223. The inner sleeve 210 includes an inner edge strip 211 and a shielding member 212, parts of edges of the shielding member 212 are detachably connected to an inner edge of the inner edge strip 211, and the inner elastic member 214 is disposed on and connected to a side edge of the inner edge strip 211. The outer sleeve 220 includes an outer edge strip 221 and a grille member 222, the grille member 222 is connected to an inner edge of the outer edge strip 221, and the outer elastic member 223 is disposed on and connected to a side edge of the outer edge strip 221.

Rest three side edges of the inner sleeve 210 without connecting to the inner elastic member 214 are connected to rest three side edges of the outer sleeve 220 without connecting to the outer elastic member 223, respectively. A side edge of the inner sleeve 210 connecting to the inner elastic member 214 and a side edge of the outer sleeve 220 connecting to the outer elastic member 223 together define an opening 300, the inner sleeve 210 and the outer sleeve 220 are configured to be sleeved onto the framed car window 100 through the opening 300.

In an embodiment, the inner sleeve 210 and the outer sleeve 220 form a protective cover 200. A direction in which the framed car window 100 descends is a first direction, and the protective cover 200 is pulled over the opening 300 from a top of the framed car window 100 along the first direction; until the opening 300 reaches a bottom of the framed car window 100, at this time the inner sleeve 210 is located on a side of the framed car window 100 facing an interior of the car, the outer sleeve 220 is located on a side of the framed car window 100 facing an exterior of the car, and a frame of the framed car window 100 will be positioned between the inner sleeve 210 and the outer sleeve 220 and will be supported against the protective cover 200.

A side edge of the shielding member 212 close to the inner elastic member 214 is connected to the inner edge of the inner edge strip 211, and rest side edges of the shielding member 212 are detachably connected to the inner edge of the inner edge strip 211. A connection between the shielding member 212 and the inner edge strip 211 is provided with an inner chain 213, which is connected using a zipper structure. When the rest three sides of the shielding member 212 are detached from the inner edge of the inner edge strip 211, there is still a side connected to the inner edge strip 211, which facilitates the reinstallation of the shielding member 212. The inner elastic member 214 and the outer elastic member 223 use elastic ropes and are disposed at the edges of the inner sleeve 210 and the outer sleeve 220 by sewing.

The inner edge strip 211, the shielding member 212, and the outer edge strip 221 are a fabric material. The grille member 222 is made of mesh fabric as used in the related art. When the shielding member 212 and the framed car window 100 are opened, the grille member 222 acts as a barrier that allows air to enter the interior of the car while preventing insects and other foreign objects from entering the car. In addition, it serves as a sunshade device under low sunlight intensity, blocking some of ultraviolet rays without affecting ventilation. In strong sunlight conditions, after the framed car window 100 is closed, the shielding member 212 can be pulled up to act as a second layer of isolation. An outdoor-facing surface of the shielding member 212 has an anti-radiation coating that can effectively reduce the penetration of the ultraviolet rays, thereby preventing some ultraviolet rays from penetrating the framed car window 100 and entering the car. The car window sunshade protective cover achieves multiple functions to meet the needs for sun protection, mosquito-proofing, and shading under different conditions during driving.

In an embodiment, the outer edge strip 221 is provided with a first connecting piece 2241 and a second connecting piece 2242, and the first connecting piece 2241 is overlapped and connected with and the second connecting piece 2242. A Velcro is provided on overlapping surfaces between the first connecting piece 2241 and the second connecting piece 2242. An installation hole 2243 is defined between the first connecting piece 2241 and the second connecting piece 2242, which accommodates the passage of a support rod of the car rearview mirror 400.

In the embodiment, the first connecting piece 2241 and the second connecting piece 2242 use a structure of the Velcro to achieve overlapping, which enhances the connection between the protective cover 200 and the car door. The first connecting piece 2241 is provided with a hair surface of the Velcro 231, and the second connecting piece 2242 is provided with a hook surface of the Velcro 232. The hair surface of the Velcro 231 and the hook surface of the Velcro 232 cooperate with each other to complete the connection. The inner elastic member 214 and the outer elastic member 223 are made of an elastic material, and by contracting the size of the opening 300 through the action of elasticity, the inner elastic member 214 and the outer elastic member 223 fit as closely as possible to a contour of the car door.

In an embodiment, the shielding member 212 includes a first shielding member 2121 and a second shielding member 2122. When the inner sleeve 210 and the outer sleeve 220 are sleeved onto the framed car window 100, the second shielding member 2122 is disposed to be closer to a car rearview mirror 400 than the first shielding member 2121. The shielding member 212 is connected to the inner edge of the inner edge strip 211 through a zipper connection manner, and the side edge of the second shielding member 2122 facing away from the first shielding member 2121 is connected to the inner edge of the inner edge strip 211 via the zipper connection manner.

In the embodiment, the shielding member 212 can adopt an integrated structure, where the shielding member 212 is fixedly connected to the side edge of the inner edge strip 211, and the rest side edges are connected to the inner edge of the inner edge strip 211 via the zipper connection manner; or the shielding member 212 can adopt a modular design, with an independently connected second shielding member 2122 set on a side close to the car rearview mirror 400. After the first shielding member 2121 is connected, the second shielding member 2122 can be detached independently, facilitating the driver's observation of the car rearview mirror 400 through the opening of the second shielding member 2122; further meeting the driving needs.

It should be noted that, for the sake of simplicity in description, the above embodiments are all described as a series of action combinations. However, those skilled in the art should understand that the disclosure is not limited to the order of actions described, as some steps may be carried out in a different order or simultaneously according to the disclosure. Secondly, those skilled in the art should also be aware that the embodiments described in the specification are preferred embodiments, and the actions and modules involved are not necessarily essential to the disclosure.

The above embodiments are provided for illustrative purposes only to illustrate the technical solution of the disclosure, and are not intended to limit the scope of protection of the disclosure. It is evident that the described embodiments are merely a part of the embodiments of the disclosure, not all of them. All other embodiments obtained by those skilled in the art without creative effort based on these embodiments fall within the scope of protection of the disclosure. Although the disclosure has been described in detail with reference to the above embodiments, those skilled in the art can still, without making creative efforts and without conflict, combine, add, delete, or otherwise adjust the features of the various embodiments as appropriate, to obtain different technical solutions that do not essentially deviate from the conception of the disclosure. These technical solutions also fall within the scope of protection of the disclosure.

What is claimed is:

1. A car window sunshade protective cover, applied to a framed car window (100), the car window sunshade protective cover comprising:
an inner sleeve (210), wherein the inner sleeve (210) comprises an inner edge strip (211) and a shielding member (212), and parts of edges of the shielding member (212) are detachably connected to an inner edge of the inner edge strip (211);
an outer sleeve (220), wherein the outer sleeve (220) comprises an outer edge strip (221) and a grille member (222), and the grille member (222) is connected to an inner edge of the outer edge strip (221);
an inner elastic member (214), wherein the inner elastic member (214) is disposed on and connected to a side edge of the inner edge strip (211); and
an outer elastic member (223), wherein the outer elastic member (223) is disposed on and connected to a side edge of the outer edge strip (221);
wherein a side edge of the inner sleeve (210) connecting to the inner elastic member (214) and a side edge of the outer sleeve (220) connecting to the outer elastic member (223) together define an opening (300), and the inner sleeve (210) and the outer sleeve (220) are configured to be sleeved onto the framed car window (100) through the opening (300).

2. The car window sunshade protective cover as claimed in claim 1, wherein rest three side edges of the inner sleeve (210) without connecting to the inner elastic member (214) are connected to rest three side edges of the outer sleeve (220) without connecting to the outer elastic member (223), respectively.

3. The car window sunshade protective cover as claimed in claim 2, wherein a side edge of the shielding member (212) close to the inner elastic member (214) is connected to the inner edge of the inner edge strip (211), and rest side edges of the shielding member (212) are detachably connected to the inner edge of the inner edge strip (211).

4. The car window sunshade protective cover as claimed in claim 3, wherein the outer edge strip (221) is provided with a first connecting piece (2241) and a second connecting piece (2242), and the first connecting piece (2241) is overlapped and connected with and the second connecting piece (2242).

5. The car window sunshade protective cover as claimed in claim 4, wherein a Velcro is provided on overlapping surfaces between the first connecting piece (2241) and the second connecting piece (2242).

6. The car window sunshade protective cover as claimed in claim 5, wherein the shielding member (212) is connected to the inner edge of the inner edge strip (211) through a zipper connection manner.

7. The car window sunshade protective cover as claimed in claim 5, wherein the shielding member (212) comprises a first shielding member (2121) and a second shielding member (2122); when the inner sleeve (210) and the outer sleeve (220) are sleeved onto the framed car window (100), the second shielding member (2122) is disposed to be closer to a car rearview mirror 400 than the first shielding member (2121).

8. The car window sunshade protective cover as claimed in claim 7, wherein a side edge of the first shielding member (2121) close to the inner elastic member (214) is connected to the inner edge strip (211), the first shielding member (2121) is movably connected with the second shielding member (2122), and a side edge of the first shielding member (2121) facing away from the second shielding member (2122) is movably connected to the inner edge of the inner edge strip (211).

9. The car window sunshade protective cover as claimed in claim 8, wherein a side edge of the second shielding member (2122) close to the inner elastic member (214) is connected to the inner edge strip (211), and a side edge of the second shielding member (2122) facing away from the first shielding member (2121) is movably connected to the inner edge of the inner edge strip (211).

10. The car window sunshade protective cover as claimed in claim 1, wherein each of the inner elastic member (214) and the outer elastic member (223) is made of an elastic material, and the inner elastic member (214) and the outer elastic member (223) are pressed against a contour of a car door by a force of elasticity.
